(19) United States
(12) Patent Application Publication
(10) Pub. No.: US 2013/0129605 A1
(43) Pub. Date: May 23, 2013

(54) Lime Slaking Process

(71) Applicants: Richard W. Christy, Eagleville, PA (US); Michael Quici, Ambler, PA (US); Louis Litz, Ambler, PA (US)

(72) Inventors: Richard W. Christy, Eagleville, PA (US); Michael Quici, Ambler, PA (US); Louis Litz, Ambler, PA (US)

(73) Assignee: RDP TECHNOLOGIES, INC., Norristown, PA (US)

(21) Appl. No.: 13/302,241

(22) Filed: Nov. 22, 2011

(51) Int. Cl. C04B 2/04

(52) U.S. Cl. 423/640

(57) ABSTRACT

A lime slaking process is provided, whereby lime is delivered from a silo into a slaking vessel, and water is likewise delivered from one or more sources, into the slaking vessel, such that unreacted lime will go through a hydration process in an exothermic reaction, and wherein the temperature of the lime being slaked in the slaking vessel is monitored and controlled via a computer that responds to the monitored temperature of lime being slaked, to add additional water and/or lime, as desired. The delivery of lime from a lime silo to the slaking vessel is via a volumetric feeding apparatus. Following the slaking process, the reacted lime and water, in the form of a slurry may be delivered to an aging tank, and subsequently to a gravity operated grit classifier. Water from the slurry may be drawn off for use at one or more dosing stations.

### THE PRESENT INVENTION

The present invention is directed to a process for treating waste water, sewage sludge and/or purifying drinking water via a lime slaking process.

### BACKGROUND OF THE INVENTION

Lime has been used in the treatment of sewage sludge to remove pathogens, in lime stabilization of waste water, for pasteurization of sludge and for purification of drinking water by adjusting the chemistry of the water, such as, but not limited to adjusting the pH of the water. Examples of such processes involving the use of lime can be found in U.S. Pat. Nos. 5,013,458; 5,229,011; 5,346,616; 5,401,402; 5,405,536; 5,433,844; 5,554,279; 5,618,442; and 7,416,673, the complete disclosures of which are herein incorporated by reference.

Calcium oxide (CaO), is mixed with water (H₂O) to form calcium hydroxide (Ca(OH)₂). The chemical reaction which occurs during such mixing gives off heat in the form of an exothermic reaction. When this reaction is done in the presence of excess water it is commonly referred to as lime slaking. This process is accomplished in a device known as a lime slaker. The resulting mixture of Ca(OH)₂ and water is known as a lime slurry.

The particular type of lime that is used can vary, but it will be lime that has not yet gone through a hydration reaction, such as calcium oxide, calcium carbonate, quick-lime, dolomitic lime, lime kiln dust, or cement kiln dust. The lime, of whatever kind, will be either pure calcium oxide, or will contain substantial quantities of calcium oxide, so that when it is mixed with water, it will produce calcium hydroxide and heat.

One apparatus and process that is known in the art for practicing lime slaking, is that set forth in U.S. Pat. No. 5,746,983.

### SUMMARY OF THE INVENTION

The present invention is directed to a lime slaking process in which unreacted lime and water are delivered to a slaking vessel, mixed to produce an exothermic reaction in a hydration process, and wherein the temperature of the reaction is monitored during the process, so that the addition of lime and/or water to the slaking vessel is controlled as a function of the monitored temperature of lime being slaked.

The process may be operated either as a batch system or as a continuous system. If it is operated as a continuous system, it will preferably be initiated as a batch system. Thereafter, as it is operated, a computer monitors the hydration process for its temperature, whereby the ongoing addition of water to the slaking vessel and the ongoing addition of lime to the slaking vessel will also preferably be computer controlled.

Accordingly, it is an object of this invention to provide a lime slaking process, wherein the hydration process is controlled by monitoring the temperature of lime being slaked during the hydration process, and the continued addition of lime and water is accomplished as a function of the monitored temperature of lime being slaked.

It is another object of this invention to accomplish the above object, wherein a computer controls the ongoing addition of lime and water to the slaking vessel, with the computer controlling such additions as determined by sensing the temperature in the slaking vessel.

It is a further object of this invention to accomplish the above objects, wherein the lime delivery is effected in accordance with a volumetric feeding system, whereby predetermined amounts of lime are delivered to the slaking vessel.

It is yet another object of this invention to accomplish the above objects, wherein the delivery of water to the slaking vessel is from any of a plurality of water sources.

It is a further object of this invention to accomplish the above object, wherein flow control devices are used, and are computer-controlled to effect the flow of water from any of a plurality of water sources.

Another object of this invention is to accomplish the above objects, wherein an aging tank is provided for receiving a slurry of slaked lime from the slaking vessel.

It is another object of this invention to accomplish the above object, wherein a gravity operative grit classifier separates grit from the lime slurry that is delivered from the slaking vessel to the aging tank.

Other objects and advantages of the present invention will be readily apparent upon a reading of the following brief descriptions of the drawing figures, the detailed descriptions of the preferred embodiments, and the appended claims.

### BRIEF DESCRIPTION OF THE DRAWING FIGURES

FIG. 1 is a schematic of the lime slaking system, aging tank, and grit classifier in accordance with this invention.

FIG. 2 is an enlarged fragmentary transverse sectional view of a one form of a volumetric feeder, by which lime is introduced into the slaking vessel, taken generally along the line II-II of FIG. 1.

FIG. 3 is a fragmentary illustration of a modified form of a volumetric feeder of lime for delivery of lime to a slaking vessel.

FIG. 4 is a fragmentary illustration of an alternative slaking vessel, in which the vessel is mounted on load cells for gravimetric control of water and/or lime to the slaking vessel.

### DETAILED DESCRIPTIONS OF THE PREFERRED EMBODIMENTS

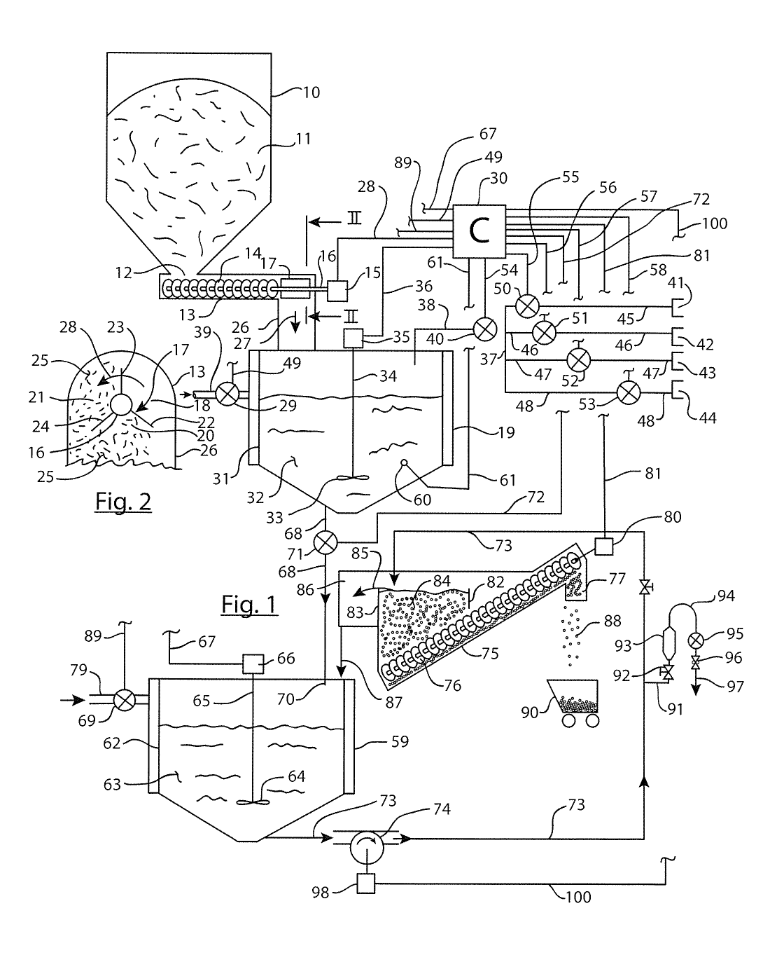

Referring now to the drawings in detail, reference is first made to FIG. 1, wherein a lime silo 10 is shown, having unreacted lime 11 therein for discharge out silo exit 12, into a lime delivery apparatus 13, having a rotating auger 14 therein for receiving lime via the silo exit 12 and delivering the same rightwardly to a discharge chute 26 upon rotation of the shaft 16 on which the auger 14 is mounted, as powered by a motor 15 that is preferably a variable speed drive motor, of a preferably electrical type.

Above the chute 26, the volumetric feeder 17 is located, also shaft driven at 16, with the volumetric feeder 17 being comprised of a three pockets 18, 20 and 21, separated by radial arms 22, 23 and 24, substantially equidistantly spaced apart, so that, upon rotation of the shaft 16 in the direction of the arrow 28, as shown, lime 25 from the right end of the auger 14 will enter into the pockets 18, 20 and 21, to be rotatingly moved downward, so that the lime falls at 25, through the chute 26, in the direction of the arrow 27, into the slaking vessel 31.

It will be understood that other forms of volumetric feeder other than that 17 illustrated herein may be used, within the scope of this invention, and that the lime delivery apparatus could comprise a structure other than the auger 14, such as a moving belt, a paddle conveyor, or any other lime delivery apparatus.

The motor 15 is controlled from a computer 30 that is preferably a programmable logic computer (PLC), via control line 28, which controls the rotation of the shaft 16, at any desired, selected speed.

Water is added into the lime slaker 31, as will be described hereinafter. The water and lime in the slaker 31 undergoes the exothermic reaction during the hydration process, to produce a slurry. In the vessel 31 a mixer 33 is provided, shaft driven at 34 via an electric motor 35 that is operated from the computer 30 via motor control line 36.

The computer 30 also controls the flow of water supplied to the slaking vessel 31 via flow line 38, with the computer 30 controlling a valve 40 via control line 54.

The water that is provided through flow line 38 may be provided from any of a number of sources 41, 42, 43 and/or 44. These sources can be from wells, rivers, streams, municipal water, or preheated water, such as might be obtained, for example, from a water jacket 19, 59 around either or both of the slaking vessel 31 and aging tank 62 or from any other sources, as may be desired. The computer 30 may control the flow of water from these sources 41-44 through their respective flow lines 45, 46, 47 and 48, by controlling whether or not valves 50, 51, 52 and 53, respectively, are open or closed via respective control lines 55, 56, 57 and 58, as shown.

The computer 30, upon receiving a signal from the temperature sensor 60 via line 61, can also optionally control the opening and closing of one or more valves 29, 69 in water feed lines 39 and/or 79, for feeding heated water to one or more water jackets 19 and/or 59 around vessel 31 and/or tank 62 via one or more control lines 49 and/or 89.

A temperature sensor 60, of any selected type will respond to the temperature of the hydration reaction occurring within the slaking vessel 31, and communicate that temperature information via line 61 to the computer 30, to which the computer 30 will respond, adding water and/or lime into the vessel 31 as a function of the monitored temperature of lime being slaked in the vessel 31.

During the hydration reaction, the temperature of the lime being slaked is continuously monitored for controlling the ratio of water to lime being provided to the slaking vessel as a function of the monitored temperature of the lime being slaked. This is to maintain a temperature of lime within the slaking vessel that is within the range of 180° F. to 210° F. Ideally, the computer will maintain this temperature at a predetermined set point that is preferably, essentially, 187° F.

As water is being mixed with lime, it is essential that the temperature be continually monitored in order to avoid boiling, in order to prevent damage to any personnel in the area, and in order to avoid undesirable disruptions in the slaking process.

As mentioned above, the slaking process can be either done as a batch process or as a continuous process. If done as a batch process, lime will be provided to the slaking vessel, from any desired source, but often the same will be provided from a lime silo. Water is then added and the temperature during the slaking process is monitored, in order to control the temperature of the hydration process, to maintain the temperature within a predetermined range, that is 180° F. to 210° F. Often the ratio of water to lime will be about 4 parts water to about one part lime. At the end of the hydration process, the hydrated lime can then be discharged from the slaking vessel, for example, into an aging tank.

Alternatively, the system can be operated as a continuous process. During a continuous process, ordinarily, the reaction will be initiated by providing a batch of lime to the slaking vessel, and then adding water as described above with respect to a batch process. However, in a continuous process, the computer will monitor the temperature of the hydration reaction in the slaking vessel and then add either water or lime, or both, to maintain the temperature within the desired range of about 180° F. to about 200° F. During the continuous process, in order to maintain that temperature, the computer will control the extent to which additional water and/or lime is added to the slaking vessel, as needed, in order to maintain the desired temperature range.

As the hydration reaction proceeds to completion, the computer 30 can control a discharge valve 71 via control line 72, to open the valve 71, to allow discharge of slurry via discharge line 68 into an aging tank 63, through an inlet 70 thereof. The slurry 63 in the aging tank 62 may be mixed by a mixer 64, shaft driven at 65 via an electric motor 66, with the motor 66 being controlled by the computer 30 via a control line 67.

The computer 30 may also control the discharge of slurry from the aging tank 62 via discharge line 73, by operating a pump 74 from an electric motor 98 that likewise is computer controlled from computer 30 via control line 100. When so operated, the slurry can be delivered via flow line 73 to a gravity operative grit classifier 75, by which slurry 84, between walls 82 and 83 may be retained such that an auger 76 in the grit classifier 75 may engage grit within the slurry, and move the same upwardly to a grit discharge chute 77, by which larger particles of grit 88 may be withdrawn from the classifier 75, and discharged into a cart 90, or other grit takeaway device.

Continued supply of slurry to the grit classifier 75 via line 73 may produce an overflow of slurry as shown by the arrow 85, for recycling of the slurry back into the aging tank 62 via flow line 87.

Water from slurry 63 being conveyed through flow line 73 may be taken off via line 91 upon opening the valve 92 wherein grit is separated therefrom in a grit trap 93, and the water is delivered via line 94 through magnetic flowmeter 95 and pinch valve 96, to exit at line 97, to one or more dosing locations, as may be desired, as treated, clean water.

Referring now to FIG. 3, it will be seen that the lime silo 10′ contains lime 11′, that is discharged via a lime delivery device 13′, of the type having an auger 14′ therein, whereby lime is delivered from left to right, and wherein computer controlled electric motor 15′ is operated via control line 28′, to rotate the shaft 16′, such that the auger 14′ is driven at a desired, selected speed, with the auger 14′ of known volume and speed, functioning as a volumetric feeding means, feeding lime to the lime slaker (not shown), but similar to that described above with respect to FIG. 1, via lime delivery chute 26′.

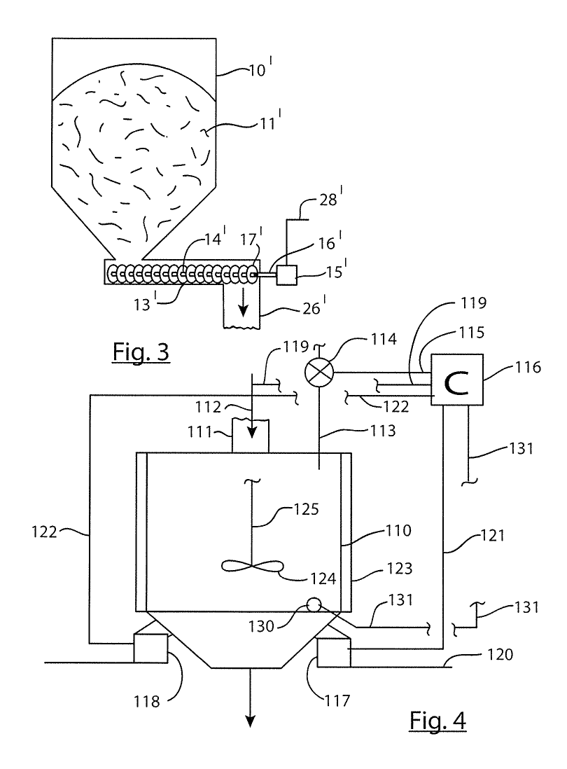

With reference now to FIG. 4, it will be seen that a slaking vessel 110 that may or may not have a water jacket 123 surrounding it, is mounted on load cells 117, 118, that, in turn, are supported on a floor or ground 120, such that the weight of the vessel 110 together with the lime and water therein at any given time, can be monitored, with such weight information being provided via lines 121, 122 to a computer 116. A temperature sensor 130 in the vessel 110 will likewise monitor the temperature of the hydration process and provide that temperature information to the computer 116, via line 131. Thus, the computer can monitor the hydration temperature on an ongoing basis, as is described above with respect to the operation of the system of FIG. 1. Thus, the computer 116, via control line 115, can control the valve 114 by which a source of water can be delivered via delivery line 113 to the slaking vessel 110, as described above.

In the embodiment of FIG. 4, in lieu of volumetric feeding of lime to the slaking tank, as is described above with respect to FIGS. 1-3, the feeding of lime to the slaking vessel 110 of FIG. 4 is accomplished by the computer 116 responding to information provided from the load cells 117, 118, via lines 121, 122, to control via control line 119 the amount of lime being added to the lime inlet 111 of the slaking vessel 110, via the lime provision line 112. It will be understood that the slaking vessel 110 will likewise be provided with a mixer 124 therein, driven via a drive shaft 125, by a suitable motor (not shown). The load cells 117, 118 may be constructed as are the load cells in U.S. Pat. No. 7,669,348, or any one or more of U.S. Pat. Nos. 5,770,823; 4,064,744; 4,166,997; 4,454,770 and 5,313,022, the compete disclosures of which are herein incorporated by reference.

It will be understood that various modifications may be made to the system and its operation, including its method steps and apparatus all within the spirit and scope of the invention as defined in the appended claims.

What is claimed is:

1. A lime slaking process comprising:
(a) providing a slaking vessel;
(b) providing lime from a lime source to the slaking vessel;
(c) providing water to the slaking vessel;
(d) mixing lime and water in the slaking vessel to produce an exothermic reaction in a hydration process; and
(e) continuously monitoring the temperature of lime being slaked during the hydration process and controlling the ratio of water to lime being provided to the slaking vessel as a function of monitored temperature of lime being slaked, to maintain a enrapture of lime being slaked in the slaking vessel that is within the range of 180° F. to 210° F.

2. The lime slaking process of claim 1, wherein the provision of lime to the slaking vessel is done as a batch process.

3. The lime slaking process of claim 1, wherein the provision of water and/or lime to the slaking vessel is done as a continuous process, in which additional water and/or lime is added to the slaking vessel, as needed, to maintain said temperature range.

4. The lime slaking process of any one of claims 1-3, wherein the monitoring and controlling includes sensing temperature in the slaking vessel, providing the temperature to a computer, with the computer controlling the ratio of water to lime provided to the slaking vessel.

5. The lime slaking process of any one of claims 1-3, wherein the monitoring and controlling includes sensing temperature in the slaking vessel, providing the temperature to a computer, with the computer controlling the ratio of water to lime provided to the slaking vessel, wherein the lime providing step includes volumetric feeding of lime to the slaking vessel.

6. The lime slaking process of any one of claims 1-3, wherein the monitoring and controlling includes sensing temperature in the slaking vessel, providing the temperature to a computer, with the computer controlling the ratio of water to lime provided to the slaking vessel, wherein the lime providing step includes gravimetric feeding of lime to the slaking vessel via at least one load cell responsive to the weight of the slaking vessel and lime and water therein and communicating that weight to the computer.

7. The lime slaking process of claim 5, including computer control of a motor drive for providing the lime to the slaking vessel.

8. The lime slaking process of claim 1, wherein the provision of water of clause (c) includes providing water from any selected one(s) of a plurality of water sources.

9. The lime slaking process of claim 8, including using a computer for controlling the provision of water from selected one(s) of the plurality of water sources.

10. The lime slaking process of claim 1, including providing an aging tank for receiving a slurry of slaked lime from the slaking vessel via a delivery line between the slaking vessel and the aging tank, and controlling the flow of slurry to the aging tank via a computer.

11. The lime slaking process of claim 10, including providing a gravity operative grit classifier for gravity separation of grit from lime slurry; and connecting the aging tank to the gravity operative grit classifier via a conduit flow control device for controlling the flow of slurry via the conduit; and computer controlling the conduit flow control device.
